(19) United States
(12) Patent Application Publication
(10) Pub. No.: US 2017/0037909 A1
(43) Pub. Date: Feb. 9, 2017

(54) CONSTANT VELOCITY JOINT

(71) Applicant: Toyota Jidosha Kabushiki Kaisha, Toyota-shi Aichi-ken (JP)

(72) Inventors: Yoshitaka Shinoda, Nagakute-shi Aichi-ken (JP); Yoshirou Kimura, Miyoshi-shi Aichi-ken (JP)

(21) Appl. No.: 15/229,581

(22) Filed: Aug. 5, 2016

(30) Foreign Application Priority Data
Aug. 7, 2015 (JP) 2015-157741

(51) Int. Cl. F16D 3/2245

(52) U.S. Cl. CPC F16D 3/2245

(57) ABSTRACT

A constant velocity joint of a vehicle includes an outer race, an inner race, a plurality of balls, and a cage. The cage holds the balls against a plurality of first ball grooves and a plurality of second ball grooves. An offset amount in a case where a joint angle is equal to or smaller than a predetermined value is larger than an offset amount in a case where the joint angle exceeds the predetermined value. The joint angle is an angle formed by an axis of the outer race and an axis of the inner race when intersecting with each other. The offset amount is a distance between a center point of a pitch circle radius as a distance between a center of each of the balls and a center of curvature of a corresponding one of the first and second ball grooves, and a joint center point.

### CROSS-REFERENCE TO RELATED APPLICATIONS

This application claims priority to Japanese Patent Application No. 2015-157741 filed on Aug. 7, 2015, the entire contents of which are hereby incorporated by reference.

### BACKGROUND

1. Technical Field

The present disclosure relates to a constant velocity joint included in a vehicle, and is particularly concerned with suppression of abnormal noise due to wedge lock of balls that constitute the constant velocity joint, and assurance of the durability of a cage.

2. Description of Related Art

A constant velocity joint of a vehicle is well known which includes an outer race in which a plurality of ball grooves are formed in its inner circumferential surface, an inner race in which a plurality of ball grooves are formed in its outer circumferential surface, a plurality of balls inserted between the ball grooves of the outer race and the ball grooves of the inner race, so as to transmit torque between the outer race and the inner race, and a cage that holds the plurality of balls. Examples of this type of joint include constant velocity joints as described in Japanese Patent Application Publication No. 2012-21608 (JP 2012-21608 A) and Japanese Patent Application Publication No. 7-91458 (JP 7-91458 A).

### SUMMARY

If an angle of nip, or an angle formed by a tangent at a contact point between the inner race and each ball and a tangent at a contact point between the outer race and the ball, is small, the ball may be stuck between the inner race and the outer race, and the constant velocity joint may lock (so-called wedge lock), which may result in occurrence of abnormal noise. While it may be considered to increase the angle of nip, so as to prevent the wedge lock of the constant velocity joint, the load applied to a cage that holds the balls increases as the nip angle increases. In particular, in a region where the joint angle is large, change of the nip angle with the rotational phase of the constant velocity joint is larger than that in the case where the joint angle is small; therefore, variations appear in the load applied to the respective balls of the constant velocity joint, and the maximum value of the load applied to the cage is further increased, which may result in reduction of the durability of the cage.

The present disclosure provides a constant velocity joint of a vehicle, which can curb occurrence of abnormal noise due to wedge lock of balls, while suppressing increase of the input load applied to a cage.

A constant velocity joint of a vehicle according to one aspect of the present disclosure includes an outer race, an inner race, a plurality of balls, and a cage. The outer race has a plurality of first ball grooves in an inner circumferential surface. The inner race is disposed radially inwardly of the outer race. The inner race has a plurality of second ball grooves in an outer circumferential surface. The plurality of balls are inserted between the plurality of first ball groves and the plurality of second ball grooves so as to roll along the plurality of first ball grooves and the plurality of second ball grooves. The plurality of balls is configured to transmit torque between the outer race and the inner race. The cage holds the plurality of balls against the plurality of first ball grooves and the plurality of second ball grooves. An offset amount in a case where a joint angle is equal to or smaller than a predetermined value is larger than an offset amount in a case where the joint angle exceeds the predetermined value. The joint angle is an angle formed by an axis of the outer race and an axis of the inner race when intersecting with each other. The offset amount is a distance between a center point of a pitch circle radius as a distance between a center of each of the balls and a center of curvature of a corresponding one of the plurality of first ball grooves and the plurality of second ball grooves, and a joint center point.

In the constant velocity joint of the vehicle according to the above aspect of the present disclosure, if the offset amount is increased, the angle of nip increases, based on the geometric relationship between the offset amount and the nip angle. Thus, the offset amount is set in advance to be large when the joint angle is equal to or smaller than the predetermined value, so that the nip angle is increased, and abnormal noise due to wedge lock of the balls can be curbed. Also, since the magnitude of swinging of the balls is small when the joint angle is equal to or smaller than the predetermined value, change of the nip angle with the rotational phase of the joint is also small, and variations in the load applied to the respective balls are reduced. As a result, the input load applied to the cage will not be large. When the joint angle exceeds the predetermined value, the offset amount is set to be smaller than that in the case where the joint angle is equal to or smaller than the predetermined value. Therefore, the nip angle will not be large, and the input load applied to the cage is less likely or unlikely to increase. Accordingly, the durability of the cage is prevented from being reduced due to increase of the input load to the cage.

In the constant velocity joint of the vehicle according to the above aspect of the present disclosure, a track of a pitch circle of each of the plurality of first ball grooves and a track of a pitch circle of each of the plurality of second ball grooves may be formed such that the pitch circle before change of the offset amount and the pitch circle after change of the offset amount are connected with a smooth curve.

According to the constant velocity joint of the vehicle as described above, the ball groove track does not suddenly change when the offset amount changes; therefore, the rolling performance of the balls is prevented from deteriorating.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an external view of a constant velocity joint of a vehicle according to one embodiment of the present disclosure;

FIG. 2 is a cross-sectional view of the constant velocity joint of FIG. 1;

FIG. 3 is a view useful for explaining the angle of nip;

FIG. 4 is a view showing the relationship between the rotational phase of the constant velocity joint and the nip angle;

FIG. 5 is a view showing the relationship of forces applied among a ball, ball grooves, and a cage;

FIG. 6 is a cross-sectional view of an outer race of the constant velocity joint of FIG. 2;

FIG. 7 is a cross-sectional view of an inner race of the constant velocity joint of FIG. 2; and

FIG. 8 is a view showing the relationship between the nip angle and the offset amount.

### DETAILED DESCRIPTION OF EMBODIMENTS

One embodiment of the present disclosure will be described in detail with reference to the drawings. In the following embodiment, some components or parts in the drawings are simplified or deformed as needed, and the dimension ratios, shapes, etc. of the respective components or parts depicted in the drawings are not necessarily accurate.

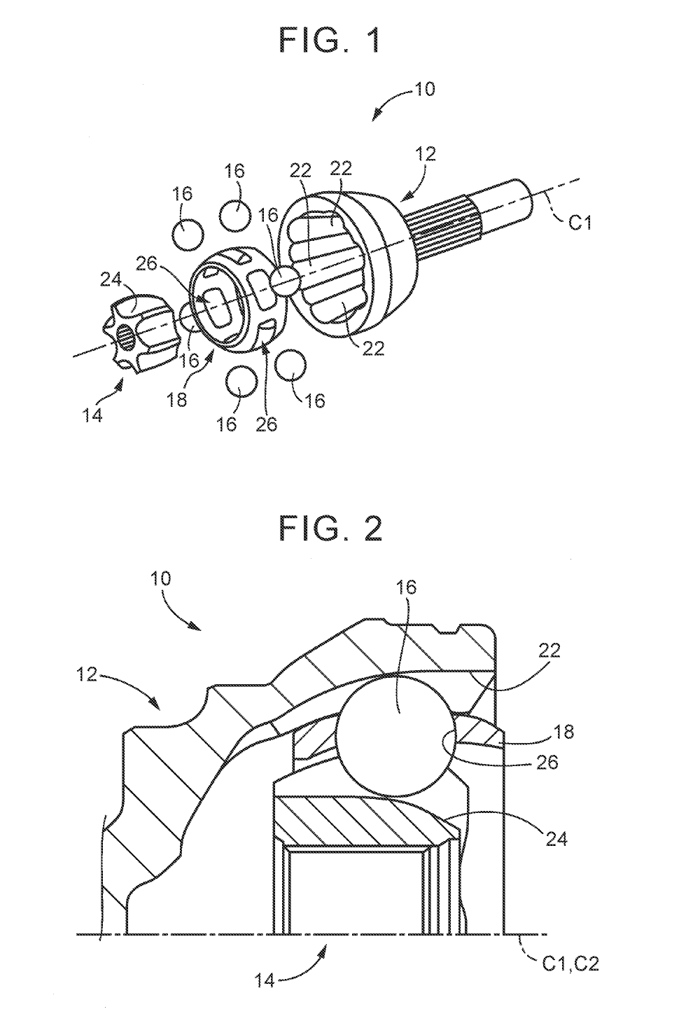

FIG. 1 is an external view of a constant velocity joint 10 of a vehicle according to one embodiment of the present disclosure. FIG. 2 is a cross-sectional view of the constant velocity joint 10. The constant velocity joint 10 includes an outer race 12, an inner race 14 disposed radially inwardly of the outer race 12, a plurality of balls 16 (six balls in this embodiment) inserted between the outer race 12 and the inner race 14, and a cage 18 that holds the balls 16 against outer ball grooves 22 (which will be described later) of the outer race 12 and inner ball grooves 24 (which will be described later) of the inner race 14.

The outer race 12 is a member that is rotatable about an axis C1 as the center of rotation of the outer race 12, and is formed in the shape of a bowl that is open at one side in the axial direction. Also, a rotary shaft is coupled to the other side of the outer race 12 opposite to its opening in the axial direction. In an inner circumferential surface of a bowl-like portion of the outer race 12, a plurality of outer ball grooves 22 whose number is the same as that of the balls 16 are formed at equiangular intervals in the circumferential direction. The outer ball grooves 22 are formed in parallel with the axis C1. The outer ball grooves 22 correspond to the above-mentioned plurality of first ball grooves.

The inner race 14 is an annular member that is rotatable about an axis C2 as the center of rotation of the inner race 14, and is disposed radially inwardly of the bowl-like portion of the outer race 12. In an outer circumferential surface of the inner race 14, a plurality of inner ball grooves 24 whose number is the same as that of the balls 16 are formed at equiangular intervals in the circumferential direction. The inner ball grooves 24 are formed in parallel with the axis C2. Also, spline teeth that engage with a rotary shaft (not shown) are formed in an inner circumferential surface of the inner race 14. The inner ball grooves 24 correspond to the above-mentioned plurality of second ball grooves.

The balls 16 each having a spherical shape are inserted between the outer ball grooves 22 of the outer race 12 and the inner ball grooves 24 of the inner race 14 in radial directions. The balls 16 can roll (or swing) in the axial direction of the outer ball grooves 22 and the inner ball grooves 24. When the balls 16 move in the circumferential direction of the outer ball grooves 22 and the inner ball grooves 24, the balls 16 engage with the outer ball grooves 22 and the inner ball grooves 24, to be moved in the circumferential direction in accordance with rotation of the outer ball grooves 22 and the inner ball grooves 24. Accordingly, torque is transmitted via the balls 16, between the outer race 12 and the inner race 14. Also, the balls 16 roll (or swing) in the axial direction of the outer ball grooves 22 and the inner ball grooves 24, according to tilt or inclination of the constant velocity joint 10, and return to the original positions when the constant velocity joint 10 makes one rotation.

The cage 18 has an annular shape, and has a plurality of holding holes 26 whose number is the same as that of the balls 16, such that the holding holes 26 are formed at equiangular intervals in the circumferential direction. The balls 16 are respectively received in the holding holes 26. Thus, the balls 16 are held by the cage 18 at equiangular intervals.

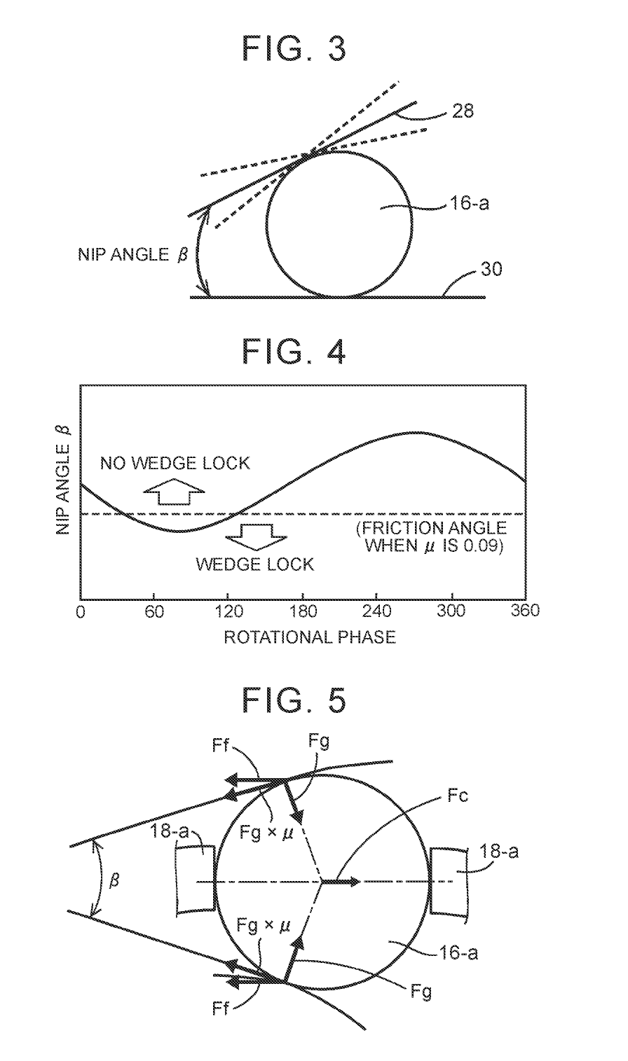

In a conventional constant velocity joint, there is a possibility of occurrence of wedge lock to the constant velocity joint, when the joint angle θ is about 6 to 10 degrees, in a normal angle range of about 0 to 10 degrees, depending on design conditions, lubrication state, etc. of the constant velocity joint. Here, the wedge lock is a phenomenon that the balls get stuck or caught between the outer ball grooves and the inner ball grooves and cannot be pushed out. The joint angle θ is an angle formed by the axis of the outer race and the axis of the inner race. While the balls of the constant velocity joint are sandwiched between the outer ball grooves and inner ball grooves (which will be referred to as “ball grooves” when they are not particularly distinguished) and pushed out, wedge lock occurs when an angle of nip β is smaller than a friction angle, or the coefficient of friction at contact portions is large. The angle of nip, or nip angle, β is an angle of intersection in space, which is formed by a tangent 28 of a ball 16-a (of the conventional ball joint as distinguished from that of this embodiment) and a corresponding outer ball groove, and a tangent 30 of the ball 16-a and a corresponding inner ball groove, as shown in FIG. 3. The friction angle is an angle of nip at which the ball 16-a stops being pushed out from between the outer ball groove and the inner ball groove, namely, an angle of nip at a limit where wedge lock occurs.

FIG. 4 shows the relationship between the rotational phase of the constant velocity joint, and the nip angle β. More specifically, FIG. 4 shows the relationship in the case where the nip angle β varies as the ball 16-a rolls (or swings) on the ball grooves while the constant velocity joint is rotating. Where the broken line indicated in FIG. 4 represents the friction angle when the coefficient of friction μ is 0.09, wedge lock occurs at angles smaller than the broken line (in a region where the rotational phase is about 50 to 120 degrees in FIG. 4). In order to avoid the wedge lock, it may be considered to move the nip angle β upward over the entire region, namely, increase the nip angle β, so that the nip angle β indicated by the solid line in FIG. 4 does not fall below the friction angle indicated by the broken line.

FIG. 5 shows the relationship of forces that act among the ball 16-a, ball grooves, and the cage 18-a (of the conventional constant velocity joint as distinguished from that of this embodiment). In FIG. 5, where a load applied to the ball 16-a at a point of contact between the ball 16-a and each ball groove is denoted as ball groove load Fg, and a load applied to the cage 18-a is denoted as cage load Fc (input load), the ball groove load Fg and the cage load Fc have a relationship as indicated by Eq. (1) below. The cage load Fc provides force that acts in such a direction as to push out the ball 16-a from between the ball grooves of the outer race and inner race. Where Ff represents a load that acts in a direction opposite to that of the cage load Fc at a point of contact between the ball 16-a and each ball groove, the load Ff is expressed by Eq. (2) below. In Eq. (2), μ corresponds to the coefficient of friction between the ball 16-a and the ball groove.

Fc=2×Fg×sin(β/2) (1)

Ff=Fg×μ×cos(β/2) (2)

As shown in FIG. 5, the load Ff acts at two locations, i.e., a contact point between the ball groove of the outer race and the ball 16-a, and a contact point between the ball groove of the inner race and the ball 16-a; therefore, the sum of the loads that act in the direction opposite to that of the cage load Fc is 2×Ff. The sum (2×Ff) of the loads provides force that acts in a direction in which the ball 16-a is locked (wedge-locked) between the ball grooves of the outer race and inner race. Accordingly, if wedge lock is supposed to occur when the sum (2×Ff) of the loads that act in the direction opposite to that of the cage load Fc is larger than the load Fc (2×Ff>Fc), the wedge lock would be curbed when μ is smaller than tan(β/2) (μ<tan(β/2), as is understood from Eq. (1) and Eq. (2). Namely, the wedge lock is curbed if the nip angle β exceeds the friction angle. Thus, the wedge lock is curbed if the nip angle β is increased; however, if the nip angle β increases, the cage load Fc increases, as is understood from Eq. (1). In a region where the joint angle θ is large, in particular, the amount of rolling (amount of swing) of the ball 16-a is large, and change (the magnitude of fluctuation shown in FIG. 4) of the nip angle β is large; therefore, variations in the load applied to the ball 16-a become large, and the maximum value (peak value) of the cage load Fc applied to the cage 18-a becomes large. Accordingly, if the nip angel 13 is increased, the wedge lock is curbed, but the cage load Fc increases, which may result in reduction of the durability of the cage 18-a.

In the constant velocity joint 10 of this embodiment, the nip angle β is set to be large in a region (normal angle range) in which the joint angle θ is equal to or smaller than a predetermined value θ1 set in advance, and is set to be small when the joint angle θ falls within a large angle range that exceeds the predetermined value θ1. The predetermined value θ1 is set in advance within the normal angle range (e.g., about 0 to 10 degrees).

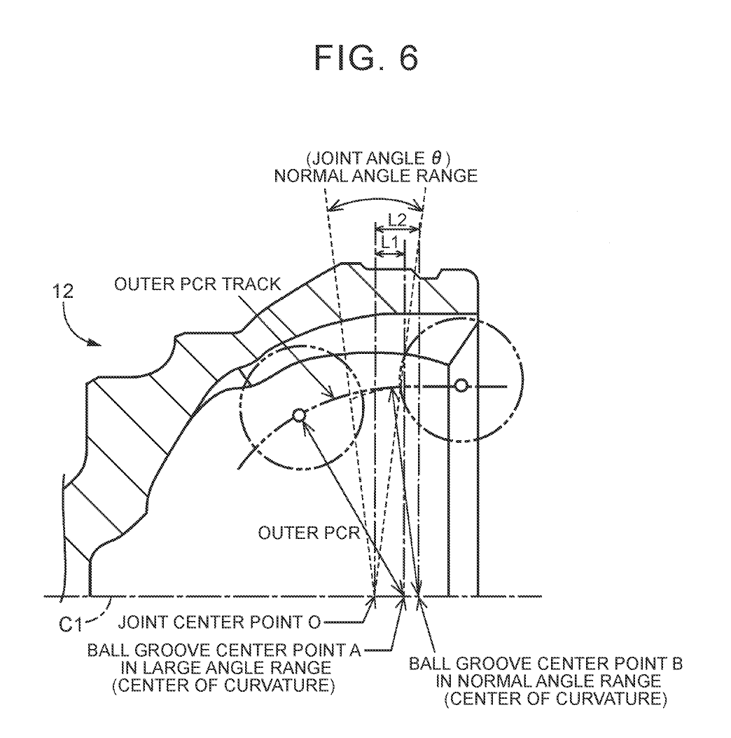

FIG. 6 is a cross-sectional view of the outer race 12 of the constant velocity joint 10 of FIG. 2. In FIG. 6, a joint center point O is a point at which a line that is perpendicular to the axis C1 and passes the center of each ball 16 when the joint angle θ is 0 degree intersects with the axis C1. When the joint angle θ is 0 degree, the balls 16 rotate about the axis C1 without rolling (swinging). Also, when the joint angle θ is 0 degree, the nip angle β is constant irrespective of the rotational phase of the constant velocity joint 10.

A ball groove center point A as a center point (center of curvature) of a pitch circle radius (outer PCR) of each outer ball groove 22, when the joint angle θ is in a large angle range exceeding the predetermined value θ1, is set at a position that is shifted from the joint center point O toward the opening of the outer race 12 along the axis C1, by a predetermined offset amount L1. The pitch circle radius (outer PCR) of the outer ball groove 22 is a distance between the center of the ball 16 and the center of curvature of the track of the center of the ball 16 which changes arcuately (i.e., ball groove center point). The track of the center of the ball 16 when the ball 16 moves on the outer ball groove 22 is depicted with an arc and a straight line indicated by a two-dot chain line, and the radius of the arc corresponds to the pitch circle radius (outer PCR) of the outer ball groove 22. Accordingly, the ball groove center point A corresponds to the center of curvature of the track of the center of the ball 16 which changes arcuately. The outer ball groove 22 is formed, so that the center of the ball 16 moves along an arc of the pitch circle radius (outer PCR) of the outer ball groove 22, which is set in advance using the ball groove center point A as its center, when the joint angle θ is in the large angle range. Thus, when the joint angle θ is in the large angle range that exceeds the predetermined value θ1, the ball 16 moves along the arc depicted about the ball groove center point A with the pitch circle radius (outer PCR). Thus, the large angle range that exceeds the joint angle θ1 in this embodiment corresponds to a region, when defined based on the outer race 12, in which the ball 16 moves arcuately on the outer ball groove 22, and a region in which the ball 16 moves along the arc depicted about the ball groove center point A with the pitch circle radius (outer PCR).

Also, a ball groove center point B as a center point (center of curvature) of the pitch circle radius (outer PCR) of the outer ball groove 22, when the joint angle θ is in a region (normal angle range) that is equal to or smaller than the predetermined value θ1, is set at a position that is shifted from the joint center point O along the axis C1 by an offset amount L2 that is larger than the offset amount L1. The outer ball groove 22 is formed, so that the center of the ball 16 moves along an arc of a pitch circle radius (outer PCR) of the outer ball groove 22, which is set in advance using the ball groove center point B as its center, when the joint angle θ is in the normal angle range that is equal to or smaller than the predetermined value θ1. The length of the outer PCR centered at the ball groove center point A is equal to that of the outer PCR centered at the ball groove center point B.

While the track (pitch circle) of the ball 16 about the ball groove center point B assumes a track indicated by the broken line in FIG. 6, a step or a difference in radial position is formed in the track of the ball 16 when the joint angle θ exceeds the predetermined value θ1 and the track of the ball 16 is switched to the track for the large angle range (track centered at the ball groove center point A). If such a step is formed, the rolling performance of the ball 16 is reduced; therefore, in fact, the tracks at a boundary where the joint angle θ switches from the normal angle range to the large angle range are connected with a smooth curve, as indicated by a one-dot chain line in FIG. 6, so that the track of the pitch circle of the ball 16 changes smoothly. The outer ball grooves 22 are formed so as to satisfy the above condition.

Thus, in the outer race 12, the offset amount L2 as the distance between the ball groove center point B in the normal angle range in which the joint angle θ is equal to or smaller than the predetermined value θ1, and the joint center point O, is set larger than the offset amount L1 in the large angle range in which the joint angle θ exceeds the predetermined value θ1. Accordingly, in the outer race 12 of this embodiment, the track of each outer ball groove 22 (track of the center of the ball 16) is formed from two arcs of different offset amounts L1, L2 and a straight line.

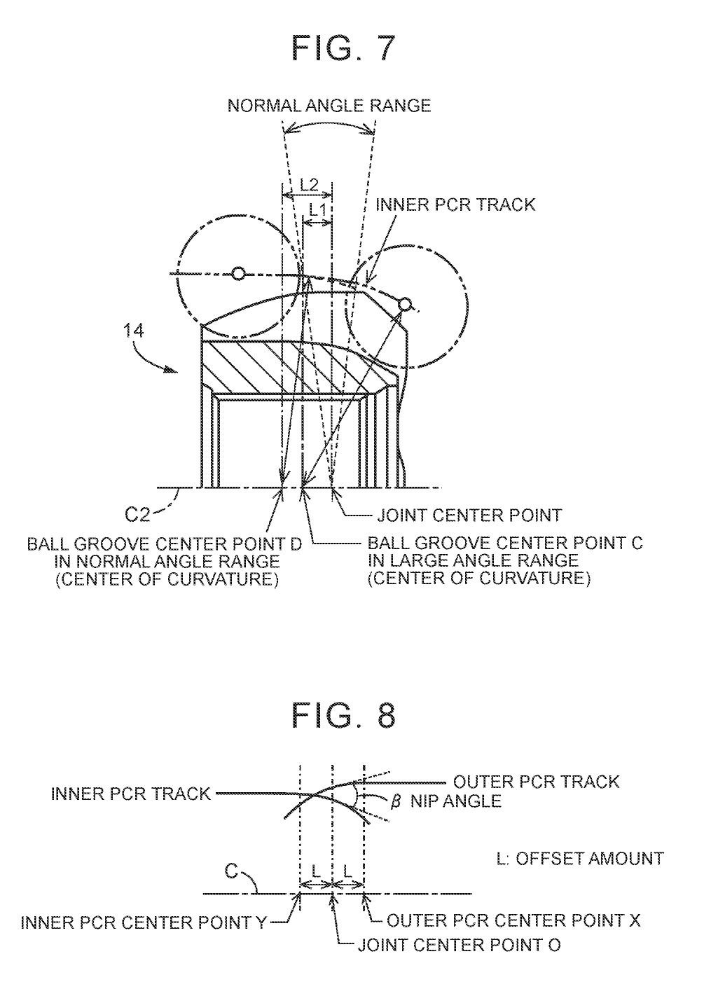

FIG. 7 is a cross-sectional view of the inner race 14 of the constant velocity joint 10 of FIG. 2. In FIG. 7, the joint center point O is a point at which a line that is perpendicular to the axis C2 and passes the center of each ball 16 when the joint angle θ is 0 degree intersects with the axis C2. When the joint angle θ is 0 degree, the ball 16 rotates about the axis C2 without rolling.

A ball groove center point C as a center point (center of curvature) of a pitch circle radius (inner PCR) of each inner ball groove 24, when the joint angle θ is in a large angle range that exceeds the predetermined value θ1, is set at a position that is shifted from the joint center point O toward the distal end of the inner race 14 (to the left in FIG. 7) along the axis C2 by a predetermined offset amount L1. The pitch circle radius (inner PCR) of the inner ball groove 24 is a distance between the center of the ball 16 and the center of curvature of the track of the center of the ball which changes arcuately (i.e., the ball groove center point). The track of the center of the ball 16 when the ball 16 moves on the inner ball groove 24 is depicted with an arc and a straight line indicated by a two-dot chain line, and the radius of the arc corresponds to the pitch circle radius (inner PCR) of the inner ball groove 24. Accordingly, the ball groove center point C corresponds to the center of curvature of the track of the center of the ball 16 which changes arcuately. The inner ball groove 24 is formed, so that the center of the ball 16 moves along an arc of the pitch circle radius (inner PCR) of the inner ball groove 24, which is set in advance using the ball groove center point C as its center, when the joint angle θ is in the large angle range. Thus, the large angle range of the joint angle θ, when defined based on the inner race 14, corresponds to a region in which the ball 16 moves arcuately on the inner ball groove 24, and a region in which the ball 16 moves along an arc depicted about the ball groove center point C with the pitch circle radius (inner PCR).

Also, a ball groove center point D as a center point (center of curvature) of the pitch circle radius (inner PCR) of the inner ball groove 24, when the joint angle θ is equal to or smaller than the predetermined value θ1 (normal angle range), is set at a position that is shifted from the joint center point O along the axis C2 by an offset amount L2 that is larger than the offset amount L1. The inner ball groove 24 is formed, so that the center of the ball 16 moves along an arc of the pitch circle radius (inner PCR) of the inner ball groove 24, which is set in advance using the ball groove center point D as its center. The length of the inner PCR centered at the ball groove center point C is equal to the length of the inner PCR centered at the ball groove center point D.

While the track (pitch circle) of the ball 16 about the ball groove center point D assumes a track indicated by the broken line in FIG. 7, a step or a difference in radial position is formed in the track of the ball 16, when the joint angle θ exceeds the predetermined value θ1 and the track of the ball 16 is switched to the track for the large angle range (track centered at the ball groove center point C). If such a step is formed, the rolling performance of the ball 16 is reduced; therefore, in fact, the tracks at a boundary where the joint angle θ switches from the normal angle range to the large angle range are connected with a smooth curve, as indicated by a one-dot chain line in FIG. 7. The inner ball groove 24 is formed so as to satisfy the above condition.

Thus, in the inner race 14, too, the offset amount L2 as the distance between the ball groove center point D in the normal angle range in which the joint angle θ is equal to or smaller than the predetermined value θ1, and the joint center point O, is set larger than the offset amount L1 in the large angle range in which the joint angle θ exceeds the predetermined value θ1. Accordingly, in the inner race 14 of this embodiment, the track of the inner ball groove 24 (track of the center of the ball 16) is formed from two arcs of different offset amounts L1, L2 and a straight line.

As described above, in the outer race 12 and the inner race 14, the offset amount L2 in the normal angle range in which the joint angle θ is equal to or smaller than the predetermined angle θ1 is set larger than the offset amount L1 in the large angle range that exceeds the predetermined angle θ1. Advantageous effects obtained from this arrangement will be described.

FIG. 8 shows the relationship between the nip angle β and the offset amount L. An outer PCR center point X as the center of the outer PCR as the pitch circle radius of the outer ball groove 22 is taken at a position shifted from the joint center point O along the axis C by the offset amount L, and an outer PCR track as an arc centered at the outer PCR center point X is illustrated in FIG. 8. Also, an inner PCR center point Y as the center of the inner PCR as the pitch circle radius of the inner ball groove 24 is taken at a position shifted from the joint center point O by the offset amount L to the side opposite to the outer PCR center point X, and an inner PCR track as an arc centered at the inner PCR center point Y is illustrated in FIG. 8.

In FIG. 8, an angle formed by the outer PCR track and the inner PCR track that intersect with each other is defined as angle of nip p. From the geometrical relationship shown in FIG. 8, the offset amount L is expressed by Eq. (3) below. In Eq. (3), the PCR indicates the average value of the outer PCR and the inner PCR. It will be understood from Eq. (3) that the nip angle β can be increased by increasing the offset amount L.

L=PCR×sin(β/2) (3)

Referring back to FIG. 6 and FIG. 7, the offset amount L2 as the distance from the joint center point O to the ball groove center point B, D corresponding to the normal angle range is larger than the offset amount L1 as the distance from the joint center point O to the ball groove center point A, C corresponding to the large angle range. Accordingly, when the joint angle θ is in the normal angle range that is equal to or smaller than the predetermined value θ1 the nip angle β is larger than the nip angle β in the large angle range, as is understood from Eq. (3). Thus, if the offset amount is set so that the nip angle β becomes large in the normal angle range, and the nip angle β becomes larger than the friction angle over the entire rotational phase of the constant velocity joint 10, wedge lock is curbed in the normal angle range. On the other hand, in the large angle range in which the joint angle θ exceeds the predetermined value θ1, the offset amount L1 is smaller than the offset amount L2, and therefore, the nip angle β is reduced to be smaller than that in the normal angle range, as is understood from Eq. (3). Accordingly, the cage load Fc applied to the cage 18 is less likely or unlikely to increase, and the durability of the cage 18 is prevented from being reduced. In the large angle region, too, it is desirable that the nip angle β is larger than the friction angle; in this case, it is possible to curb wedge lock in the large angle range, too, while suppressing increase of the cage load Fc.

As described above, according to this embodiment, if the offset amount L2 between the ball groove center point B, D of the ball groove 22, 24 and the joint center point O is increased, the nip angle β is increased, based on the geometrical relationship between the offset amount L2 and the nip angle β. Thus, in the region where the joint angle θ is equal to or smaller than the predetermined value θ1, the offset amount L2 is increased, so that the nip angle β becomes large, and abnormal noise due to wedge lock of the ball 16 can be curbed. Also, since rolling (swing) of the ball 16 is reduced, in the normal angle range in which the joint angle θ is equal to or smaller than the predetermined value θ1, change of the nip angle β with the rotational phase of the joint 10 is small; therefore, variations in the load applied to the respective balls 16 are reduced, and the cage load Fc (input load) applied to the cage 18 will not be large. Also, in the large angle range in which the joint angle θ exceeds the predetermined value θ1, the offset amount L1 is smaller than the offset amount L2 in the case where the joint angle θ is equal to or smaller than the predetermined value θ1; therefore, the nip angle β will not be large, and increase of the cage load Fc applied to the cage 18 is suppressed. Accordingly, reduction in the durability of the cage 18 due to increase of the cage load Fc is prevented.

According to this embodiment, it is possible to prevent the rolling performance of the balls 16 from deteriorating, by smoothly changing the ball groove tracks when changing the offset amounts L1, L2.

While one embodiment of the present disclosure has been described in detail with reference to the drawings, this embodiment may be applied in other forms.

For example, six balls 16 are provided in the above-described embodiment, but the number of the balls 16 may be changed as appropriate.

Also, in the above-described embodiment, a specific numerical value of the predetermined value θ1 of the joint angle θ may be changed as appropriate, according to the shape of the constant velocity joint, and the shape of the vehicle.

It is to be understood that what has been described above is a mere embodiment, and that the embodiment can be carried out with various changes and improvements, based on the knowledge of those skilled in the art.

What is claimed is:

1. A constant velocity joint of a vehicle, comprising:
an outer race having a plurality of first ball grooves in an inner circumferential surface;
an inner race disposed radially inwardly of the outer race, the inner race having a plurality of second ball grooves in an outer circumferential surface;
a plurality of balls inserted between the plurality of first ball groves and the plurality of second ball grooves so as to roll along the plurality of first ball grooves and the plurality of second ball grooves, the plurality of balls being configured to transmit torque between the outer race and the inner race; and
a cage that holds the plurality of balls against the plurality of first ball grooves and the plurality of second ball grooves, wherein
an offset amount in a case where a joint angle is equal to or smaller than a predetermined value is larger than an offset amount in a case where the joint angle exceeds the predetermined value, the joint angle being an angle formed by an axis of the outer race and an axis of the inner race when intersecting with each other, the offset amount being a distance between a center point of a pitch circle radius as a distance between a center of each of the balls and a center of curvature of a corresponding one of the plurality of first ball grooves and the plurality of second ball grooves, and a joint center point.

2. The constant velocity joint of the vehicle according to claim 1, wherein
a track of a pitch circle of each of the plurality of first ball grooves and a track of a pitch circle of each of the plurality of second ball grooves are formed such that the pitch circle before change of the offset amount and the pitch circle after change of the offset amount are connected with a smooth curve.
